(19) United States
(12) Patent Application Publication
(10) Pub. No.: US 2005/0177425 A1
(43) Pub. Date: Aug. 11, 2005

(54) System and a method for soliciting recruits

(76) Inventor: Csaba Sziklai, Park City, UT (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/777,383

(22) Filed: Feb. 11, 2004

(51) Int. Cl. G06F 17/60

(52) U.S. Cl. 705/14; 705/1

(57) ABSTRACT

A method of soliciting potential employees to an industry includes identifying the potential employee, generating a personalized message for the potential employee on a referral unit, generating a solicitation letter for the potential employee, coupling a media source including general information about career choices by a practicing psychologist to the referral unit, and transmitting the referral unit, the media source, and the solicitation letter to the potential employee.

### BACKGROUND

A number of methods have traditionally been used for soliciting employees in various fields. Traditional methods of soliciting include placing advertisements in the help wanted section of a newspaper, developing billboard advertisements, producing television commercials, offering recruiting incentives to existing employees, etc.

However, many industries suffer from a negative public perception. Consequently, few potential employees tend to consider the industry as a possible career choice. Typically, this negative recruiting trend results in an employee shortage, under qualified applicants, and/or industry failure.

Additionally, direct approaches touting the benefits of the disparaged industry as a possible career choice are typically met with resistance from potential candidates. This resistance may stem from the noticeably biased slant that is applied to current employee solicitation techniques. This noticeable bias further limits the opportunity of sincere consideration in the minds of potential recruits.

### SUMMARY

A method of soliciting potential employees to an industry includes identifying the potential employee, generating a personalized message for the potential employee on a referral unit, generating a solicitation letter for the potential employee, coupling a media source including general information about career choices by a practicing psychologist to the referral unit, and transmitting the referral unit, the media source, and the solicitation letter to the potential employee.

In another embodiment, a system for recruiting potential employees includes a card, a protective sleeve coupled to the card, and a media storage source disposed in the protective sleeve, the media storage source including a recorded message targeted at motivating a general career search by potential employees.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a perspective view illustrating an advocacy recruiting referral unit according to one exemplary embodiment described herein.

FIG. 2 is a block diagram illustrating a recruitment media display set-up according to one exemplary embodiment described herein.

FIG. 3 is a flow chart illustrating a method for recruiting potential candidates using the advocacy referral unit according to one exemplary embodiment.

Throughout the drawings, identical reference numbers designate similar, but not necessarily identical, elements.

### DETAILED DESCRIPTION

An exemplary system and method for eliciting recommendations is disclosed herein. More specifically, a system for recruiting potential clients includes a referral card configured to receive personalized text and/or graphics, a media protective sleeve coupled to the referral card, and a media source disposed within the media protective sleeve. The media source contained within the media protective sleeve includes a message from a practicing psychologist regarding general career search information and more specific information regarding one or more industries.

As used in this specification and in the appended claims, the term “practicing psychologist” is meant to be understood as a psychologist who is accredited by the National Association of Credential Evaluation Services (NACES).

In the following description, for purposes of explanation, numerous specific details are set forth in order to provide a thorough understanding of the present system and method for eliciting recommendations. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

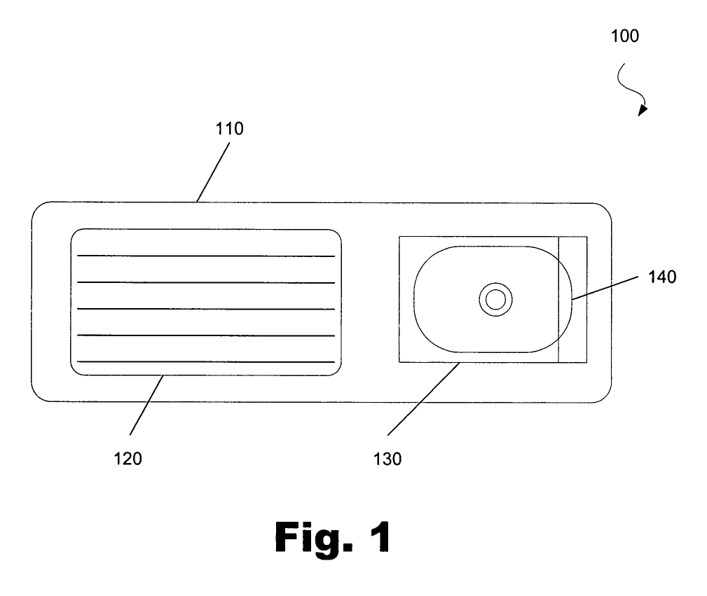

FIG. 1 illustrates an advocacy referral unit (100) that may be used to approach, recruit, and/or otherwise elicit recommendations of potential candidates for employment according to one exemplary embodiment. As illustrated in FIG. 1, the advocacy referral unit (100) may include a referral card (110) including a text receiving portion (120), a media protective sleeve (130), and a media source (140) disposed within the media protective sleeve.

According to one exemplary embodiment illustrated in FIG. 1, the referral card (110) is a text receivable medium configured to receive the attachment of the media protective sleeve (130). The referral card (110) may be constructed of any number of materials capable of receiving text and/or graphics including, but in no way limited to, paper based materials, cloth based materials, or plastic based materials. Additionally, any number of graphical illustrations may be present on the surface of the referral card (110) in order to indicate a source or theme of the advocacy referral unit (100).

A text receiving portion (120) illustrated in FIG. 1 forms an integral part of the referral card (110). According to this exemplary embodiment, the text receiving portion (120) of the referral card (110) has a contrasting color when compared to the remaining surface of the referral card. The contrasting color and optional text guiding lines may be present on the text receiving portion (120) of the referral card (110) in order to better highlight any text or graphics disposed thereon. Additionally, the texture of the text receiving portion (120) of the referral card (110) may vary from that of the remainder of the referral card (110) in order to facilitate text or image reception.

The media protective sleeve (130) illustrated in the exemplary embodiment illustrated in FIG. 1 may be any shape, size, or material sufficient to protect a media source (140) contained therein. According to one exemplary embodiment, the media protective sleeve (130) is a plastic pouch configured to protectively enclose a mini-disk as illustrated in FIG. 1. The protective sleeve is selectively coupled to the surface of the referral card (110). Fixation of the media protective sleeve (130) to the referral card (110) may be accomplished by any number of adhesives. Alternatively, mechanical fasteners such as staples or brads may be used to affix the media protective sleeve (130) to the referral card (110). Moreover, the media protective sleeve (130) may be formed as an integral part of the referral card (110). According to this exemplary embodiment, the media protective sleeve (130) may be constructed of the same material as the referral card (110) and be configured to receive and protect a media source (140).

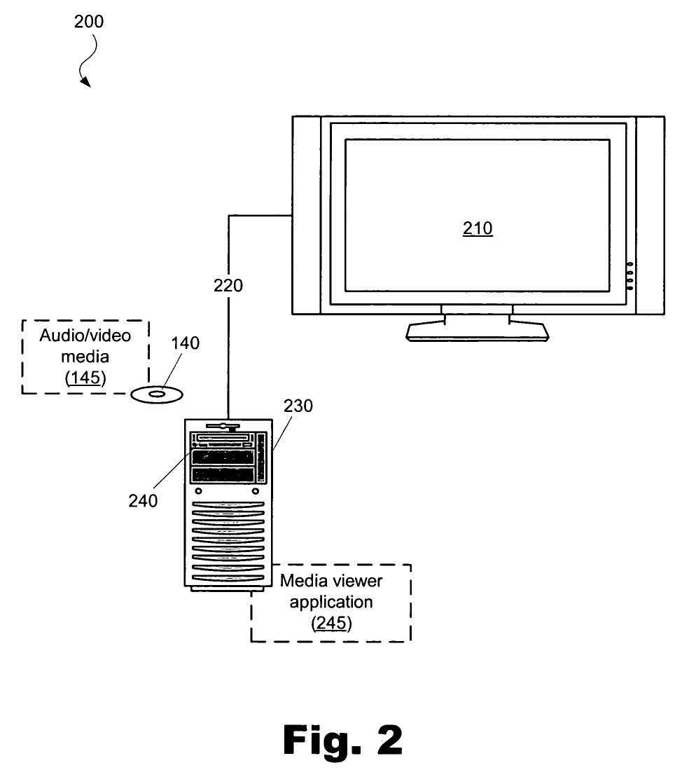

The media source (140) illustrated in FIG. 1 may be any medium capable of storing an audio and/or video message directed at potential employees. Possible structures of the media source include, but are in no way limited to, mini-disks, digital video disks (DVDs), compact audio disks (CDs), audio tapes, video tapes, etc. According to one exemplary embodiment, the media source (140) is a mini-disk approximately the size of a traditional business card. As illustrated in the exemplary embodiment shown in FIG. 1, the media source (140) includes a number of characteristics (142) provided to facilitate use with traditional media source players such as orifices for receiving media source player components. The media source may also include a number of labels and/or graphics configured to indicate a source or a theme of a message included on the media source (140). Further explanation of the message included on the media source (140) will be given below with reference to FIG. 2.

FIG. 2 illustrates an exemplary media display system (200) that may be used to view the message included on the media source (140). As illustrated in FIG. 2, the media display system (200) includes the media source (140) with an audio and/or video message (145) contained thereon. The media display system also includes a media access component (230) containing a media source player (240). The media access component (230) and its associated media source player (240) may include, but are in no way limited to, a computer and disk drive, a digital video disk (DVD) player, a mini-disk player, a video-cassette recorder (VCR), or any other media player corresponding to the media source (140) utilized. Additionally, as illustrated in FIG. 2, the media access component (230) includes a media viewer application (245) configured to access the audio and/or video message (145) contained on the media source (140) and generate an image and/or audio signal that can be transmitted to a display device (210).

As shown in FIG. 1, the media access component (230) is communicatively coupled to a display device (210). The display device (210) may include a visual display device such as a television, a video monitor, or any other device that can display still and/or video images, including for example, a cathode ray tube set, a liquid crystal display, a plasma television, etc. Additionally, in the case of displaying a strictly audio message (145), the display device may include any number of loudspeakers. The display device (210) is communicatively coupled to the media access component (230) through a connection (220) that allows the media access component (230) to send message data (still, video, or audio) to the display device (210). The connection (220) may be, for example, a direct cable, a network connection, or a wireless connection.

According to one exemplary embodiment, the audio and/or video media message (145) contained on the media source (140), contains a message from a practicing psychologist regarding general career choices and more specific information regarding a single industry. According to one exemplary embodiment, the single industry is the insurance and financial services industry. According to this exemplary embodiment, the audio and/or video media message (145) contained on the media source (140), is designed to motivate potential employees to assess their level of satisfaction with their current employment and further motivate them to perform a general career search. According to this exemplary embodiment, by motivating the listener to perform a general career search, the typically noticeable bias that exists with career recruitment is not present. Rather, the media message (145) contained on the media source (140) includes valuable general career search information that is attractive to people even if they have no motivation to consider the specific industry highlighted as a career choice, such as for example, the insurance and financial services industry.

According to one exemplary embodiment, the audio and/or video media message (145) contained on the media source (140) is a risk-free informational brief delivered by a practicing psychologist, designed to motivate people to engage in a process of self-examination and potentially interest them in exploring a career in the insurance and financial services industry. The present audio and/or video media message (145) differs from other handouts and brochures in that a psychologist that is an outsider to the industry is addressing the potential candidate with a topic of possible interest to him/her and by doing so paves the way for a meeting with a recruiter.

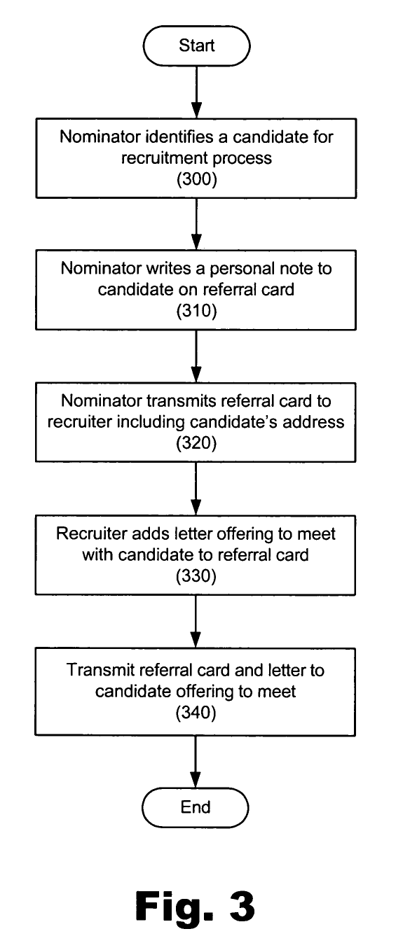

FIG. 3 illustrates an exemplary method for recruiting potential candidates using the above-mentioned referral unit (100; FIG. 1). As illustrated in FIG. 3, the method begins when a nominator identifies a candidate to participate in the recruitment process (step 300). The nominator may be a current employee of the industry performing the recruiting, a relative of the potential employee, a school counselor, or another interested party. Similarly, the candidate may be any person the nominator considers might be interested in a career in the insurance and financial services industry. Once the candidate has been identified by the nominator (step 300), the nominator writes a personal note to the candidate on the referral card (step 310). The note written on the referral card is meant to establish initial interest in the referral unit. When the candidate recognizes a familiar or personal note, curiosity will be generated and further interest in the media source will exist. After the personal note has been written, the nominator transmits the referral unit (100; FIG. 1) to a recruiter (step 420). The recruiter may be any person responsible for recruiting new employees into the industry. Once the recruiter receives the personalized referral unit, the recruiter includes an additional letter with the referral unit (step 430) and prepares the documents for transmission. The transmission of the documents may be performed using a carrier service, by an in person delivery, or by any other appropriate transmission method. According to one exemplary embodiment, the additional letter included with the referral unit by the recruiter is a letter offering to meet with the candidate if he/she is interested in further exploring the industry as a career choice. Once prepared, the referral unit and the associated letter are transmitted to the candidate (step 440) for viewing and further solicitation efforts.

In conclusion, the present system and method are configured to solicit potential employees by providing a message to the potential employees on a media source coupled to a referral card containing a handwritten message. The combination of a written personalized message and career advice in the form of a media source provides a heightened motivation for anyone receiving the referral unit to consider their career possibilities. The message directed to the potential employees contained on the media source is from a practicing psychologist regarding career choices and discussing the insurance and financial services industry. By providing the message from a practicing psychologist, traditional biases are removed and value is added to the message.

The preceding description has been presented only to illustrate and describe embodiments of the present system and method. It is not intended to be exhaustive or to limit the system and method to any precise form disclosed. Many modifications and variations are possible in light of the above teaching. It is intended that the scope of the present system and method be defined by the following claims.

1. A method of soliciting a potential employee for an industry, said method comprising:
identifying said potential employee;
generating a personalized message for said potential employee on a referral unit;
generating a solicitation letter for said potential employee;
coupling a media source including general information about career choices by a practicing psychologist to said referral unit; and
transmitting said referral unit, said media source, and said solicitation letter to said potential employee.

2. The method of claim 1, wherein said media source further comprises information regarding said industry.

3. The method of claim 2, wherein said media source comprises one of a mini-disk, a digital video disk (DVD), a compact audio disk (CD), an audio tape, or a video tape.

4. The method of claim 1, wherein said identifying said potential employee comprises obtaining a referral from one of a relative of said potential employee, a current employee of an industry performing said solicitation, or a school counselor.

5. The method of claim 1, wherein said industry comprises an insurance and financial services industry.

6. The method of claim 1, wherein said referral unit comprises:
a card;
said card being composed of one of a paper based product, a fabric based product, or a plastic based product.

7. The method of claim 6, wherein said card further comprises:
a section configured to receive said personalized message;
said section including a plurality of text guide lines.

8. The method of claim 1, wherein said solicitation letter is generated by a recruiter for said industry.

9. The method of claim 8, wherein said solicitation letter comprises an offer to meet with said potential employee.

10. A system for soliciting potential employees, said system comprising:
a card;
a protective sleeve coupled to said card; and
a media storage source disposed in said protective sleeve, said media storage source including a recorded message targeted at motivating a general career search by said potential employees.

11. The system of claim 10, wherein said card comprises one of a one of a paper based product, a fabric based product, or a plastic based product.

12. The system of claim 11, wherein said card further comprises:
a section configured to receive a personalized message;
said section including a plurality of text guide lines.

13. The system of claim 10, wherein said media storage source comprises one of a mini-disk, a digital video disk (DVD), a compact audio disk (CD), a tape, a videocassette, or a flash memory module.

14. The system of claim 10, wherein said recorded message is generated by an impartial third party.

15. The system of claim 14, wherein said impartial third party comprises a practicing psychologist

16. The system of claim 10, wherein said protective sleeve comprises a plastic pouch configured to house said media storage source.

17. The system of claim 10, wherein said protective sleeve forms and integral part of said card.

18. The system of claim 10, wherein said protective sleeve is coupled to said card by one of an adhesive or a mechanical fastener.

19. A system for recruiting potential employees comprising:
a means for receiving a personalized message;
a means for protecting a media storage source coupled to said message receiving means; and
a media storage source disposed in said protective means, said media storage source including a message recorded by a practicing psychologist, said message being targeted at motivating a general career search by said potential employees.

20. The system of claim 19, wherein said means for receiving a personalized message comprises a card manufactured from one of a one of a paper based product, a fabric based product, or a plastic based product.

21. The system of claim 20, wherein said card further comprises a plurality of text guide lines.

22. The system of claim 19, wherein said media storage source comprises one of a mini-disk, a digital video disk (DVD), a compact audio disk (CD), a tape, a videocassette, or a flash memory module.

23. The system of claim 19, wherein said protective means comprises a plastic pouch configured to house said media storage source.

24. The system of claim 19, wherein said protective means forms and integral part of said means for receiving a personalized message.

25. The system of claim 19, wherein said protective means is coupled to said card by one of an adhesive or a mechanical fastener.
